(19) United States
(12) Patent Application Publication
(10) Pub. No.: US 2009/0199447 A1
(43) Pub. Date: Aug. 13, 2009

(54) Refill monitoring system for food services and consummable items

(76) Inventors: Jeffrey Wallace, Bridgeville, PA (US); David P. Gaudio, Camegie, PA (US)

Correspondence Address: THE INVENTORS NETWORK, INC., 332 ACADEMY STREET, CARNEGIE, PA, 15106, US

(21) Appl. No.: 12/322,873

(22) Filed: Feb. 9, 2009

Related U.S. Application Data
(60) Provisional application No. 61/063,977, filed on Feb. 8, 2008.

(51) Int. Cl. G09F 3/10

(52) U.S. Cl. 40/637

(57) ABSTRACT

A refill monitoring system that is either imprinted or impressed directly on the item or container such as packaging, cups, bottles, cans, bags, or the refill monitoring system can be embodied in the form of a sticker or label affixed or adhered to the exterior surface of the container and the refill monitoring system including indicia printed thereon indicating the company and/or logo, the address of the business and other germane information, and legal verbiage explaining the particular business establishment's refill policy, and indicia generally in the form of circles that can be punched, marked, mutilated for denoting each discrete instance of product refill so that the employees/owners of the establishment can easily and visually track the number of refills per customer thereby preventing abuse and waste and monitoring and controlling expenses.

### FIELD OF THE INVENTION

The present invention pertains to product use and consumption tracking and monitoring systems, and more particularly pertains to a tracking and monitoring system for refill and presale items, products or services.

### BACKGROUND OF THE INVENTION

Inventory monitoring and control is vital for the success of any business, whether the business is a mom and pop store, a small franchise, a medium-sized corporation, or a multi-national corporation. Inventory monitoring and control is accomplished in a number of different ways that range from the use of traditional accounting firms to the increasing use of RFID (radio frequency identification) to track the sales of very large numbers of product. Moreover, inventory monitoring and control must be tailored to each specific business and industry for maximum effectiveness. Thus, the requirements for inventory monitoring and control of a large manufacturing concern differ considerably from the inventory monitoring and control for the food service industry and establishments that include the sale of consumable food products and items. Such establishments can range from restaurants, amusement park eateries, coffee shops and sporting venues to movie theaters, ice cream stands and local and county carnivals and fairs. In many cases such establishments provide free refills of beverages and consumable items as a way to build customer loyalty, increase overall sales, and differentiate their establishments. However, there is always the potential for abuse in any such sale and marketing practice. Thus, without some sort of means or method to actually track the amount of consumable beverage and food refills being made, a policy of free refills can easily be a money loser. This is an especial concern for small business establishments that operate on very small profit margins. Given that many employees of such small business establishments are teenagers, retirees, and semi-skilled to unskilled workers, the means or method to track refills—and also pre-sales—to avoid abuse while still maintaining the free refill policy must be simple, easy to implement, generally free of complex computerized functions and techniques, and readily and easily discernible and understandable to both the employees of the business establishments and the customers that avail themselves of the free refill policy.

The prior art thus discloses various product and sale labeling and tracking practices and methods.

For example, the Mangini et al. patent (U.S. Pat. No. 5,048,870) discloses a label for pharmaceutical products that includes a multi-part flag label that includes a plurality of self-adhesive stickers each of which is completed with the germane information and applied to appropriate container(s).

The Baker et al. patent (U.S. Pat. No. 5,884,292) discloses a system for smart card funds refill that includes a system for providing items of value, charging the items to a smart card, and recharging the smart card, and the system including a data center for communicating with the system to recharge the smart card.

The Amhof et al. patent (U.S. Pat. No. 6,238,623 B1) discloses a labels and tracking systems for sterilization procedures with especial use for tracking hydrogen peroxide sterilization procedures.

The Lapp patent (U.S. Pat. No. 6,745,509 B1) an integrated coupon dispenser and promotional signage product that improves the visibility and eye-catching ability of point-of-purchase (POP) coupon dispensing devices.

Nonetheless, despite the ingenuity of the above devices, there remains a need for an easy-to-use system for monitoring and tracking the refilling and redeeming of products of services.

### SUMMARY OF THE INVENTION

The present invention comprehends a refill monitoring system for monitoring and tracking the refills of any type of food beverage, product or service, or any type of consumable item, in a simple, direct cost effective manner so that abuse of the refill policy can be avoided, waste can be eliminated, and expenses and revenues can be more tightly monitored and controlled. The refill monitoring system can also be used in the presale of various types of items and services.

The refill monitoring system can either be imprinted or impressed directly on the item or container such as packaging, bottles, cups, cans, bags, etc., or the refill monitoring system can be embodied in the form of a sticker or label affixed or adhered to the exterior surface or side of the container. The refill monitoring system will have printed thereon indicia for the company and/or product logo, the address of the business and other germane information, legal verbiage explaining the particular business establishment's refill policy, and indicia generally in the form of circles that can be punched, marked, mutilated for denoting each discrete instance of a product refill so that the employees of the establishment can easily and visually track the amount of refills per customer.

It is an objective of the present invention to provide a refill monitoring system for any food service product or consumable item that can be directly printed on the cup, bottle, container, bag, lid or packaging, or which can be applied thereto as a sticker or label.

It is another objective of the present invention to provide a refill monitoring system for presale items and services.

It is yet another objective of the present invention to provide a refill monitoring system that allows the business establishment to monitor and restrict the times and dates of refills and redemptions for the food and beverage products and items.

It is still yet another objective of the present invention to provide a refill monitoring system that will create more revenue when used with presale items and products.

Still another objective of the present invention is to provide a refill monitoring system that will prevent the abuse of refill policies and will allow for the control of expenses and losses thereby enhancing revenues.

Still yet another objective of the present invention is to provide a refill monitoring system that is cost effective and requires no initial setup or investment expenditures.

Still yet a further objective of the present invention is to provide a refill monitoring system that ends the giveaway of product and saves on the expenditure of an electronic or computerized tracking system.

Yet another objective of the present invention is to provide a refill monitoring system that can be used in movie theaters, amusement parks, food service industry, retail and service industry, sports venues, fairs, and specialty entertainment (circuses, auto racing, etc.) venues.

These and other objects, features, and advantages will become apparent to those skilled in the art upon a perusal of the following detailed description when read in conjunction with the following detailed description and accompanying drawing figures.

### BRIEF DESCRIPTION OF THE DRAWINGS

FIG. 1 is a perspective view of the refill monitoring system of the present invention illustrating the indicia included on the monitoring system when used for presale items or products;

FIG. 2 is a perspective view of the refill monitoring system of the present invention illustrating the system in label or sticker form affixed to the side of a coffee cup;

FIG. 3 is a perspective view of the refill monitoring system of the present invention illustrating the system in label or sticker form affixed to the side of a beverage container;

FIG. 3a is a side elevational view of the refill monitoring system of the present invention illustrating the front side of refill monitoring system in label form and the rear side with an adhesive applied or coated thereon;

FIG. 4 is a perspective view of the refill monitoring system of the present invention illustrating the system in label or sticker form affixed to the side of a bag containing popcorn; and

FIG. 5 is a front elevational view of the refill monitoring system of the present invention illustrating typical indicia for the monitoring system in sticker or label form.

### DETAILED DESCRIPTION OF THE PREFERRED EMBODIMENT

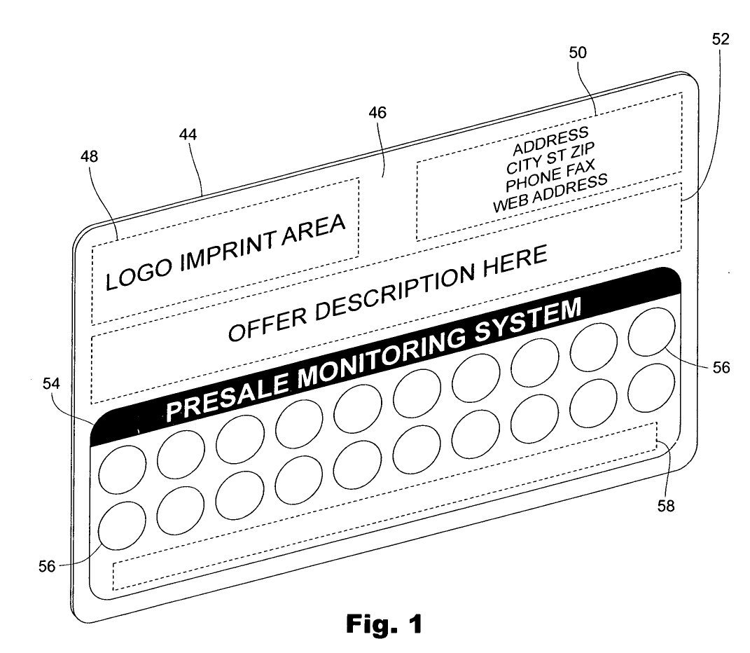

Illustrated in FIGS. 1-5 is a refill monitoring system 10 for tracking and monitoring refills of any food service item or product or any consumable food item or product be it in solid, liquid or beverage form. The refill monitoring system 10 of the present invention can also be used to presale various food items and products for creating additional revenue and generating additional advance sales for the business establishment. The refill monitoring system 10 allows the employees and the owner(s) of the business establishment to monitor and track the amount and numbers of refills and redeemed products, items or services in order to prevent the abuse of the refill or redemption policy and to more efficiently control losses and expenses.

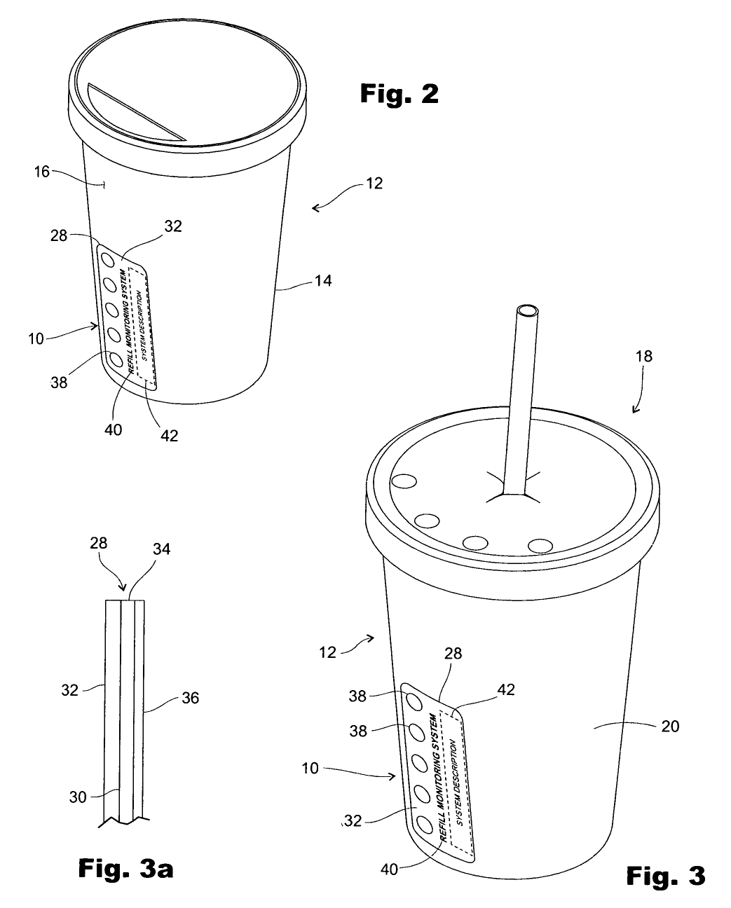

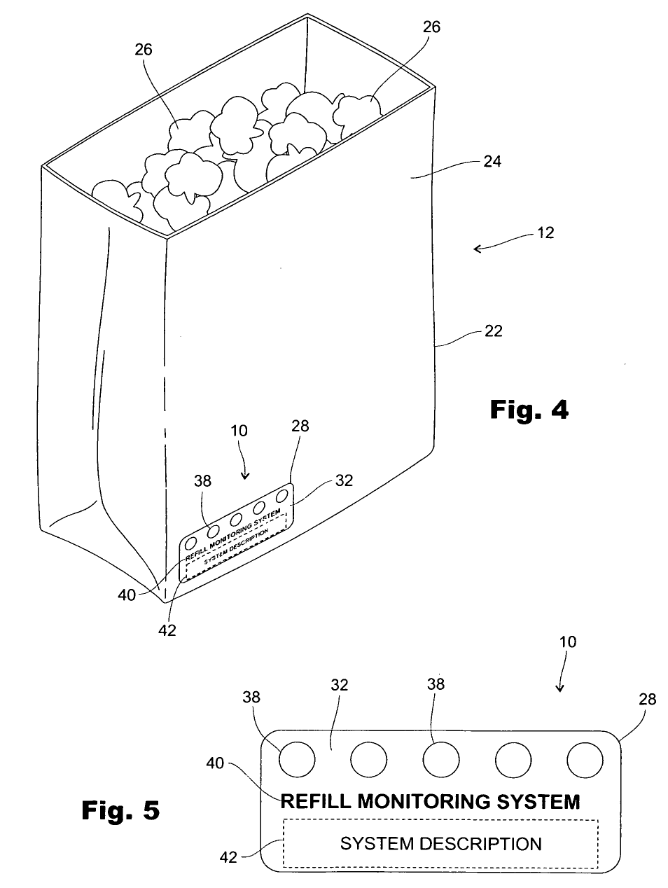

Thus, as shown in FIGS. 1-5, the refill monitoring system 10 when embodied in a tangible form is applied or affixed to the side or external surface of a container 12 such as representative containers that can include a coffee cup 14 having an external surface 16 as shown in FIG. 2, a beverage container 18 having an external surface 20 as shown in FIG. 3, and a popcorn bag 22 having an external surface 24 and which is shown in FIG. 4. Popcorn 26 is also shown in the popcorn bag 22. The refill monitoring system 10 embodied in the tangible form thus includes a sticker or label 28 having a rear side 30 and an opposite front side 32. Printed, imprinted, or impressed on the front side 32 are various types of indicia denoting particular categories for monitoring and tracking and for denoting the particulars of the refill—or presale—policy. The rear side 30 includes an adhesive backing or substance 34 that is applied to the rear side 30 and which is covered by a peel-off protective covering 36. When it is desired to apply the refill monitoring system label to the external surface 16, 20, or 24, of the container, such as any of the containers 14, 18, 22, shown in FIGS. 2, 3, and 4, the employee simply peels off the protective covering 36 and presses the rear side 30 of the label 28 to the external surfaces 16, 20, or 24 of any of the containers 14, 18, or 22.

As shown in FIGS. 2-5, the primary indicia located on the front side 32 of the refill monitoring system label 28 include a plurality of discrete and separate circles 38 for tracking and counting the number of refills of the service, item or product. The circles 38 are designed to be punched, marked, or mutilated by pen, pencil, marker, etc. to physically and visually signify each instance of a refill. In the preferred embodiment the tracking and monitoring circles 38 are 0.25 of an inch in diameter and each circle 38 is spaced 0.25 inches from each other. Located beneath the plurality of spaced-apart tracking and monitoring circles 38 is the area or region for the printed system designation indicia 40 including the phrase “Refill Monitoring System.” This phrase 40 designates whether the labels or stickers 28 are being used to track and monitor the refills or the pre-sales of any type of consumable food item, product or service. Located beneath the designation indicia 40 denoting the type of system, which in FIGS. 2-5, designates the “Refill Monitoring System,” is the area or region containing or including the system description indicia 42 that states the business establishment's policy on refills. One preferred system description indicia 42 is the following: “This establishment limits refills on this item. Please check at service counter for details. Do not alter this area in any way.” The system description indicia 42 contain the implied and express legal statements. In addition, a date box and a time box can be located between the tracking and monitoring circles 38 and the indicia 40 denoting the type of system that applies to the food service item or product or consumable product. All of the above indicia 40 and 42 are printed or otherwise formed on the front side 32 of the label 28.

FIG. 1 illustrates a representative label or sticker 44 having indicia pertaining to a presale monitoring system use. Specifically, the front side 46 of the label 44 includes a Logo Imprint Area or box 48 and a Business Address (address, city, state, zip, phone, fax, email, web address) box or area 50 at the top of the label 44. The Logo Imprint Area 48 is the area where the company or business establishment's logo, trade name, trademark, or service mark can be placed. The indicia or phrase immediately below the Logo Imprint Area 48 and the Business Address area 50 is the Offer Description Here rectangle or rectangular area 52 with representative indicia contained within the rectangular area 52 including the following phrase repeated left to right and filling the Offer Description Here rectangle 52: “The description of the offer imprints here . . . ” The indicia printed beneath the Offer Description Here rectangle 52 designates the type of monitoring and tracking system and will include the printed phrase: “Presale Monitoring System.” 54. Located immediately beneath the “Presale Monitoring System” phrase 54 is a plurality of presale tracking and monitoring circles 56. In the preferred embodiment there are two rows with ten presale tracking and monitoring circles 56 in each row. After each instance of a food or beverage product, item, or service presale, the appropriate circle 56 is marked, punched, mutilated, etc. by the business employee and/or manager/owner to denote, mark and maintain a count of the number of specific product or item presales. Located beneath the presale tracking and monitoring circles 56 is the system description indicia rectangle or rectangular area 58 that includes any implied or express legal statements. The preferred indicia for the system description rectangular area 58 for the label 44 of FIG. 1 includes the following printed matter: “Do not alter this area in any way. Unauthorized duplication and/or modification of this card and/or system is prohibited and a violation of trademark, patent, and copyright laws. All/any violations will be prosecuted to the fullest extent of the law.” It should be noted that the refill monitoring system 10 and the presale monitoring system label 44 can be directly impressed or printed onto any type of containers such as containers 14, 18, and 22.

As the invention has been described and set forth herein, it will be apparent and appreciated to those skilled in the art that the same may be varied, altered, or modified in numerous and diverse ways without departing from the spirit and scope of the invention; and, as a consequence, any and all such variations, alterations, and modifications are intended to be included within the scope of the appended claims.

We claim:

1. A refill monitoring system attachable to a food and beverage container for monitoring and tracking the number of refills of food and beverage items and products, comprising:
a rectangular-shaped label having a front side and a rear side;
an adhesive substance applied to the rear side for affixing the label to the container;
a plurality of refill tracking and counting circles disposed on the front side and which are used to verify, track and count each instance of a food and beverage item and product refill;
designation indicia located on the front side beneath the refill tracking and counting circles and including the phrase: “Refill Monitoring System”; and
system description indicia located on the front side beneath the designation indicia and which sets forth the refill policy of the business establishment utilizing the refill monitoring system.

2. The refill monitoring system of claim 1 wherein the diameter of each refill tracking and counting circle is at least 0.25 inches in diameter and each refill tracking and counting circle is spaced from every other refill tracking and counting circle by at least 0.25 inches.

3. The refill monitoring system of claim 2 wherein the system description indicia includes the following phrase: “This establishment limits refills on this item. Please check at the service counter for details. Do not alter this area in any way.”

4. The refill monitoring system of claim 3 wherein the refill tracking and counting circles, the designation indicia, and the system description indicia can be printed directly onto the food and beverage container.

5. A refill monitoring system attachable to a food and beverage container for tracking and counting the number of presales of food and beverage items and products, comprising:
a rectangular-shaped label having a front side and a rear side;
an adhesive substance applied to the rear side for affixing the label to the container;
a Logo Imprint Area located on the front side and wherein the logo of the business establishment can be placed;
a Business Address Area located on the front side beside the Logo Imprint Area and wherein business address information pertaining to the business establishment is placed;
monitoring and tracking system type indicia located on the front side beneath the Logo Imprint Area and the Business Address Area and including the phrase: “Presale Monitoring System”; and
a plurality of presale tracking and monitoring circles located on the front side beneath the monitoring and tracking system type indicia for counting and tracking each instance of the food and beverage product and item resale.

6. The refill monitoring system for tracking and counting presales of food and beverage items and products of claim 5 wherein the Logo Imprint Area, the Business Address Area, the monitoring and tracking system type indicia, and the presale tracking and monitoring circles can be directly imprinted onto the food and beverage container.
